(19) United States
(12) Patent Application Publication
(10) Pub. No.: US 2024/0399979 A1
(43) Pub. Date: Dec. 5, 2024

(54) METHOD FOR PRODUCING A DECORATIVE ELEMENT, WHICH HAS A FUNCTIONAL OPENING, FOR A MOTOR VEHICLE, AND DECORATIVE ELEMENT

(71) Applicant: Lisa Dräxlmaier GmbH, Vilsbiburg (DE)

(72) Inventors: Christian SCHLEMMER, Landshut (DE); Linda PAINTNER, Landshut (DE); Wolfgang STRASSER, Aham (DE)

(73) Assignee: Lisa Dräxlmaier GmbH, Vilsbiburg (DE)

(21) Appl. No.: 18/806,354

(22) Filed: Aug. 15, 2024

Related U.S. Application Data
(63) Continuation of application No. PCT/EP2023/053009, filed on Feb. 7, 2023.

(30) Foreign Application Priority Data
Feb. 16, 2022 (DE) 10 2022 103 619.7

(51) Int. Cl. B60R 13/02; B32B 37/12; B32B 38/00

(52) U.S. Cl. CPC B60R 13/02; B32B 37/12; B32B 38/0004; B32B 2605/003

(57) ABSTRACT

A method for manufacturing a decorative element, includes a functional opening, for a motor vehicle, as well as a decorative element. A decoration blank that includes a visible side and an adhesive side, and an application material layer that includes an adhesive side, and a lamination side are provided. A composite made of the decoration blank and the application material layer is produced by the adhesive side of the decoration blank and the adhesive side of the application material layer being adhered to each other by an adhesive layer. The decoration blank is cut through along a functional opening contour by a cutting element of a cutting machine, and a waste piece is removed, forming the functional opening. The functional opening is filled with a filler material that reacts into a cured state. The opening is at least partially translucent, at least partially transparent, completely transparent, or light impermeable.

### CROSS-REFERENCE TO RELATED APPLICATIONS

This application is a continuation of International Application No. PCT/EP2023/053009, filed on Feb. 7, 2023, which claims priority to and the benefit of DE 10 2022 103 619.7 filed on Feb. 16, 2022. The disclosure of each of the above referenced application is incorporated herein by reference.

### FIELD

The present disclosure relates to a method for the manufacturing of a decorative element that includes one or more functional openings.

### BACKGROUND

The statements in this section merely provide background information related to the present disclosure and may not constitute prior art.

From DE 10 2019 135 217 A1 a visible-/interior-component for the interior of a vehicle is known that includes surface element, that has a top side and a bottom side, and is at least partially transparent in a visible spectral range. The visible-/interior-component further includes an illumination unit, using which the surface element is through-lightable with light up from the bottom side.

Nowadays soft or flexible or pliable decorative elements that include one opening or more openings, and consequently one delicate bridge or more delicate bridges can only be aligned with one another and laminated on a carrier structure with the use of particularly great effort so that a high lamination quality results. Because conventional decorative elements, or decorative elements that have been/are manufactured using conventional methods tend to form wrinkles or a warping of the decorative element during the laminating-on onto a carrier structure, in particular in the region of the corresponding functional opening or in the region of the bridges between the functional openings, above all when these bridges are particularly delicate. Furthermore, the aligning of two decorative elements over a gap or directly adjacent to each other is particularly laborious, since a consistently high repeat quality is achievable only with difficulty. Therefore particularly complex, detail-rich patterns that should be shown on the decorative element using the openings are often omitted. Furthermore, to date the applying of the decorative element on the carrier structure uses a time-intensive positioning and fixing of the decorative element, or plurality of such decorative elements, that is pliable or flexible and partially opened by the opening or openings. However, this is inefficient, and in serial production leads to undesirably long dwell times for the laminating-on of the decorative element onto the carrier structure. These issues are not solved by the conventional visible-/interior-component.

### SUMMARY

This section provides a general summary of the disclosure and is not a comprehensive disclosure of its full scope or all of its features.

The present disclosure provides a decorative element with at least one particularly detailed functional opening, which is laminatable-on onto a carrier structure particularly easily and with high lamination quality, and is particularly stable or long-lasting. In addition, the present disclosure relates to such a decorative element that is manufactured using the method. The decorative element is provided in particular for a use in the automotive sector, for example, as decorative element in an interior of a motor vehicle, in particular an automobile and/or truck. Possible applications of such a decorative element are, for example—in particular illuminated/illuminable or backlit/backlightable—symbols (warning symbols, state indicators, etc.), emblems (crests, manufacturer symbols, logos, vehicle-model- and/or model-range-names, etc.), functional decorations (interior- or ambient-lighting, button- and/or switch-surfaces, etc.), seams, seam imitations (for example, decorative seams, functional seams, cross seams, etc.)

According to the present disclosure a method is provided for the manufacturing of at least one decorative element, in which the decorative element includes one functional opening or more functional openings. Here the respective functional opening can be, for example, a light- or illumination-opening and/or function as sound opening. Such a light opening as well as such a sound opening shall be described in more detail below. The decorative element is provided for a motor vehicle, for example, for an automobile, in particular for an interior of the motor vehicle. The method is used for the manufacturing. In other words, the decorative element is a product that has been/is manufactured using the method. The method for the manufacturing of the decorative element includes the steps explained in more detail below, which can take place in a different order deviating from the order in the description. Furthermore, the steps can at least partially temporally overlap or at least partially take place simultaneously. In other words: First the individual steps that the method includes are shown; their order arises in connection with the description of the possible designs. The order of the steps possibly overlaps from possible design to possible design. In this respect the ordinal numbers used in the description for the steps do not necessarily indicate a sequence of the steps, but rather primarily offer a structured description.

In the method, in a first step, first the decoration blank and an application material layer are provided. The decoration blank can be configured pliable, rigid, or reversibly elastically flexible. In addition, the decoration blank can already include openings, a perforation, etc. before its processing using the method described herein. The decoration blank has a visible side and an adhesive side (which can also be referred to as finishing side), in which these two sides are spaced from each other by a material thickness of the decoration blank, and their surface normals oppose each other. The decoration blank is in particular a flat product made of a textile or a textile-type material, of leather, and/or artificial leather. Furthermore, film structures or rigid structures (for example, plates) made of these or other materials are conceivable, for example, made of TPO (thermoplastic polyolefin) etc. Natural, renewable, and/or synthetic leather replacement materials (apple leather, mushroom leather, eucalyptus leather, pineapple leather, etc.), hot-stamped or non-hot-stamped textiles, glass, or limitation glass, metallic materials, ceramics, wood, plastics, etc. are possible as material for the decoration blank. A material structure made of a mixed material is also conceivable, which includes, for example, one or more of the materials mentioned. If two or more decoration blanks are used, they can be made of the same or of different materials. The respective material can be transparent or non-transparent and/or permeable or impermeable for acoustic waves.

The application material layer can be configured pliable, rigid, or reversibly elastically flexible, and has an adhesive side and a lamination side that are spaced from each other by a material thickness and whose surface normals oppose each other. In particular the application layer is a textile structure, a fabric, a knitted fabric, a crocheted fabric, a mesh, a stitch-bonded fabric, a fleece, a film. The application material layer can be permeable for light, at least for such light that has a wavelength from approximately 380 nm (nanometers) to approximately 780 nm and is therefore visible for a person with physiological eyes without further aid. In other words, the application material layer is permeable for visible light. For example, the light can filter-through through meshes or other material-free spaces of the application material layer. Furthermore, it can be provided that the light filters-through directly through a material of the application material layer—i.e., for example, directly through threads—wherein then the application material layer is manufactured from an at least partially translucent or transparent, in particular transparent material offering image fidelity. Alternatively or additionally the application material layer can be coated at least regionally, for example, with an application of paint, such that it is light-permeable or lightproof at the coated locations. In addition, a color appearance of the application material layer can be adapted according to need using the application of paint.

In a further, for example, second step of the method, a composite is produced from the decoration blank and the application material layer by the adhesive side of the decoration blank and the adhesive side of the application material layer being adhered with each other—at least temporarily and/or only in the cutting region—using an adhesive. This means that in addition to the decoration blank and the application material layer, the adhesive layer or an adhesive is provided (for example, in the first step or in another step of the method) that forms the adhesive layer between the decoration blank and the application material layer during the connecting of the decoration blank with the application material layer. During the producing of the composite, the decoration blank and the application material layer are thus connected with each other in a material-bonded manner. The material of the decoration blank can have an uneven topography on the adhesive side, for example, with peaks and valleys. Here the applying or spreading of the adhesive can be intentionally controlled such that only peaks are coated with the adhesive. Alternatively the applying of the adhesive can be controlled such that both the peaks and the valleys are coated with the adhesive. In the case of a porous material of the decoration blank, the adhesive can at least partially diffuse into or be absorbed into the material. A laminating adhesive can be used in particular as adhesive, using which the completed decorative element is laminated onto the carrier structure.

The method includes in particular a further (for example, third) step, in which the composite, which includes the decoration blank, the adhesive layer, and the application material layer, is fixed in a cutting machine such that the processing of the composite can occur using the cutting machine. The composite is thus positioned in a processing region of the cutting machine and, for example, clamped, mounted, adhered (for example, using an adhesive tape), sucked using a vacuum generator onto a cutting bed or onto a cutting table of the cutting machine, etc. The composite can be fixed in the processing region of the cutting machine with preload or without preload. In this state it is possible that a cutting element of the cutting machine penetrates or cuts into a material body of the composite, whereby the composite is processed by the cutting machine or its cutting element. The cutting machine is in particular a computer-controlled cutting machine, for example, a CNC cutting machine. A laser cutting machine, in particular with a CO2 laser generator, can be provided as cutting machine. Accordingly the cutting element of the cutting machine can be, for example, a laser beam. As CNC laser cutting machine, the laser cutting machine includes a device for the electronic or computer-controlled rail-guided laser cutting. For this purpose the laser beam can be guided using a robot system. Furthermore, a fixed laser field is conceivable in conjunction with a laser scanner or a laser mirror device for directing the laser beam. The laser scanner can alternatively or additionally be moved using the robot system or a different robot system.

In a further step, which can be a fourth step, the composite is processed using the cutting machine. For this purpose the composite is cut into in the cutting machine. It can be provided that the composite is cut-through using the cutting machine. In any case the decoration blank is cut into, and in particular completely cut-through, along a prescribed or prescribable functional opening contour using the cutting machine, that is using its cutting element. Here the decoration blank can first be cut into along the functional opening contour and then cut-through along the functional opening contour. Due to the cutting-through of the decoration blank a waste piece of the composite arises that includes at least a decoration material component. If during the processing of the compound using the cutting machine both the decoration blank and the adhesive layer are cut-through, the waste piece includes both a decoration-material component and an adhesive-layer component. If during the processing of the compound using the cutting machine both the decoration blank, the adhesive layer, and the application material layer are cut-through, the waste piece includes the decoration-material component the adhesive-layer component, and an application material component. After the cutting-through of the decoration blank the waste piece is removed from the composite, whereby a first functional opening is formed or exposed.

The first functional opening is partially or completely filled with a filler material (for example, a polymer, a hotmelt, a dispersion, etc.). If the first functional opening is configured as a light opening (which can also be referred to as illumination opening or backlighting opening), the first functional opening is filled with the filler material. In the fully cured state the filler material is, for example, translucent, that is, permeable for visible light. Thus a light opening is formed from the first functional opening by it being filled with the filler material that reacts into a cured or hardened state in which it is at least partially translucent or at least partially transparent, in particular transparent with image fidelity. Here the filler material can have, for example, a milky appearance, similar to frosted glass. With a through-lighting of the filler material a diffusely distributed light thereby arises in a desired manner, which light exits from the filler material.

If the first functional opening is configured as a sound opening, it is filled with the filler material at most partially with the filler material. In this case the filler material can be selected such that it reacts into the fully cured state by the filler material being non-light-transparent or lightproof. Thus a sound opening is formed from the first functional opening by it being filled at most partially with the filler material that reacts into a fully cured or hardened state in which it is non-light-transparent or lightproof.

In any case it can be provided that the filler material is pliant, rigid, or reversibly elastically flexible, and before the inserting into the functional opening, has been brought, using chipless or chipping production methods, into a shape that corresponds to the shape of the functional opening. Furthermore it is conceivable that the filling material is brought into a liquid or at least pasty state and then inserted into the functional opening in order to cure inside the functional opening. The filler material can furthermore serve as a coating material for the coating of the lamination side of the application material layer. For the filling, the filler material can be rolled-on on the lamination side of the application material layer, for example, using a transfer roller device. Here on the one hand the functional opening is filled with the filler material since it runs into the functional opening in particular when the filler material is applied in liquid/paste onto the lamination side. On the other hand the lamination side of the application material layer is coated with the filler material by the rolling-on of the filler material, even away from the functional opening.

Using this method, the decorative element can on the one hand be particularly efficiently manufactured. On the other hand, the decorative element manufactured using the method is particularly lamination-friendly and consequently can be laminated-on onto the carrier structure particularly precisely, in particular without warpage and without wrinkling. The carrier structure is in particular an injection-molded carrier, which is coated with a layer made of a soft component (for example, a textile, a spacer fabric, a foam, etc., wherein it is not the application material layer) or at least partially comprised thereof. On this layer the decorative element can be particularly simply laminated-on by soft lamination. Alternatively the carrier structure can be configured dimensionally stable or at least have a dimensionally stable surface. On the dimensionally stable carrier structure the decorative element can be particularly easily laminated-on using hard lamination—that is, without the layer made of the soft component.

Since the decoration blank is stabilized by the application material layer during the laminating, so that the functional openings and bridges—even when these are particularly delicate, approximately only a few millimeters or less then one millimeter wide—possibly present between the functional openings do not deform in an undesired manner. A particularly high lamination quality results that in an advantageous manner can be held at a constantly high level within a production series. A time-intensive positioning of the decorative element on the carrier structure and rectifying of undesired deformations/wrinkles during the laminating-on of the decorative element can be advantageously omitted. Complex or elaborate designs are thus possible that can be produced inexpensively. Due to the mechanical (in particular computer-controlled) cutting using the cutting machine, furthermore a particularly high reproduction precision results, and thereby less waste, which leads to a particularly resource-saving manufacturing of the decorative element.

In a further example of the method, the cutting-through of the decoration blank or the processing of the composite is affected by laser cutting, that is, using a laser-cutting machine. Accordingly the cutting element is a laser beam. During the processing of the composite using the laser-cutting machine, only the decoration blank may be cut into or cut-through. Furthermore it is conceivable that under the cutting of the composite using the laser cutting machine, further layers of the composite are cut into or cut-through, for example, the adhesive layer and/or the application material layer. Here the laser cutting can occur single-step or multi-step. In particular, in a first laser-cutting partial process a first of the layers of the composite is first cut into, and in a second laser-cutting partial process following the first laser-cutting partial process is cut-through. It is also conceivable that in the first laser-cutting partial process a first of the layers of the composite is cut into or cut-through, and in the second laser-cutting partial process at least one other of the layers of the composite is cut into or cut-through. Furthermore it can be provided that all layers of the composite are cut through in a common laser-cutting process by the laser cutting.

Due to the mechanical laser cutting using the laser-cutting machine, the idea of a particularly high reproduction accuracy and consequently of a particularly resource-saving producing of the decorative element is especially taken into account. Furthermore, particularly delicate designs or patterns can be created, especially those where an inner pattern segment of the decoration blank is surrounded by a material recess, and an outer pattern segment made of the material of the decoration blank adjoins the material recess. By this pattern being directly cut using the laser-cutting machine, in which the composite is constructed in a sandwich-type manner, an always identical positional location of the internal pattern segment is provided from decorative element to decorative element. In comparison to another cutting- or stamping-method for the forming of an opening in a decoration blank, the laser cutting has still further advantages: Thus, the decoration blank is not subjected to mechanical stresses that occur during mechanical cutting or stamping due to a blade or punching body being driven through the decoration blank. The decoration blank is thereby not deformed to an undesired degree. In particular during stamping, material displacement occurs, and as the wear of the stamping body increases, this material displacement—and consequently the unwanted deformation—increases; the openings created by stamping become larger than expected, their edges become more cracked, and their geometry becomes less precise.

In the method in a further development, it is provided that the cutting element for processing the composite, i.e., for cutting through the decoration blank, strikes the visible side of the decoration blank and cuts the composite toward the lamination side of the application material layer up to a prescribed or prescribable cutting depth. Optionally, it can be provided that before cutting or laser cutting, particularly before clamping the composite in the cutting machine, the visible side is covered with a protective layer, such as a protective film, a protective lacquer, etc., to inhibit the visible side from being undesirably damaged during handling and/or processing. In order to thus protect the visible side of the decoration blank during cutting/laser cutting, aside from the cutting contour or cutting path that characterizes the functional opening contour, the protective layer can also be applied to the visible side of the decoration blank, for example, adhered. The protective layer forms a cutting aid layer, making the protective layer or cutting aid layer an additional layer of the composite. During cutting, the cutting element penetrates or cuts into the decoration blank or composite, passing through the cutting aid layer. The cutting aid layer, which has been adhered to the visible side, can be removed from the visible side without damage. In this regard, during the manufacturing of the composite, the decoration blank and the cutting aid layer can be connected to each other in a material-bonded manner. The decoration blank and/or the cutting aid layer are designed such that the material bond between the decoration blank and the cutting aid layer can be released without damaging the visible side of the decoration blank when the cutting aid layer is removed.

By cutting into the visible side of the decoration blank to create the decorative element—in particular when using laser cutting—a particularly high edge quality is achieved along the contour of the functional opening. Because fraying, scorch marks, etc., on the visible side are avoided with appropriate control of the cutting process. Furthermore, material breakage and crack formation on the finishing side or adhesive side of the decoration blank, particularly when manufactured from leather or synthetic leather, are inhibited.

According to a further example of the method, a particularly accurately cut edge of the functional opening results along its functional opening contour when the cutting element impinges against the visible side of the decoration blank at least in a first functional opening contour segment or along the entire functional opening contour parallel to a surface normal of the visible side. The surface normal is a (imaginary, mathematical-geometric) vector that extends perpendicular to the visible side. In other words, the cutting element, for example, the laser beam, impinges perpendicularly against the visible side of the decoration blank at least along the first functional opening section, and thus cuts in perpendicularly into the decoration blank and optionally in further layers of the composite.

A particularly broadly varied diversity of possible designs of the functional openings results when—as a further example of the method provides—at least in a second functional opening contour section or along the entire functional opening contour, the cutting element impinges against the visible side of the decoration blank obliquely to the surface normal of the visible side. In other words, at least along the second functional opening section the cutting element, for example, the laser beam, impinges obliquely against the visible layer of the decoration blank and thus cuts into the decoration blank, and possibly into further layers of the composite, obliquely. In this way, for example, functional openings can be generated that on the part of the adhesive side of the decoration blank or on the part of the lamination side of the application material layer have an opening surface that is larger than on the part of the visible layer of the decoration blank/decorative element. If such a functional opening functions as a light opening, at the underside of the decorative element light can penetrate particularly efficiently into the filler material, wherein the filler material can then serve as a light-collecting element or prism element. In this case light effects/light colors can mix in a particularly versatile manner in order to make possible a desired lighting out from the functional or light opening.

According to a further example of the method, a further (second) functional opening can be generated, which forms a sound opening, by cutting-through using the cutting element along a second prescribed or prescribable functional opening contour of the decoration blank, and the waste piece thereby arising being removed. Here during filling of the other functional opening, functioning as light opening, with the filling material the second functional opening, i.e., the sound opening, is filled at most partially with the filler material. In other words: the sound opening was not at all or at most partially filled with the filler material, or the sound opening remains at least partially spared from a filling with the filler material. That is, during the manufacturing of the decorative element the sound opening is partly or completely kept free of the filler material. It can be provided that the sound opening is first filled with the filler material, and then at least a part of the filler material initially filling the sound opening, or the filler material is completely removed again from the sound opening. If the decorative element has the sound opening, it can advantageously serve as cover for a loudspeaker of the motor vehicle, since sound waves that are generated by the loudspeaker can pass particularly efficiently through the sound opening into the interior of the motor vehicle. Thus the decorative element can serve as separating element between the interior and an installation space of the loudspeaker so that without functional limitation the loudspeaker already cannot be seen or discerned by an occupant of the motor vehicle. It can furthermore be provided that the first functional opening is configured as sound opening and/or that the decorative element generally only includes a single functional opening that is configured as sound opening or as light opening. Furthermore, the decorative element can include both at least one functional opening functioning as light opening and at least one functional opening functioning as sound opening. In addition the decorative element can comprise only sound openings or only light openings. The decorative element is manufacturable by the method described herein in a particularly efficient and needs based manner with the corresponding functional opening or with the corresponding functional openings.

According to a further example of the method, the decoration blank can be provided by it being formed from at least two mutually separate decoration blank parts. Here the two decoration blank parts are adhered together with the application material layer and with formation of at least one edge opening or edge gap between them. Due to the edge opening, a further (for example, third) functional opening is formed that is filled with the filler material. Alternatively a further (for example, second) sound opening is formed by the edge opening or the third functional opening, which—as presented further above—is filled at most partially with the filler material during filling of the light opening or light openings. This means the respective edge opening can function in its entirety either as a light opening or as a sound opening. Furthermore, it is conceivable that both a light opening and a sound opening are formed by the edge opening by the edge opening being filled in or filled with the filler material only partially, or the filler material being only partially removed from the edge opening. In addition, a first edge opening and a second edge opening or more edge openings can be formed, for example, when more than two decoration blank parts for the decoration blank are connected on the application material layer. Then, for example, two edge openings are formed, of which one can function as the light opening, and the corresponding other can function as sound opening. With two more edge openings, one or both of the edge openings can function partially or completely as light opening, and partially or completely as sound opening. Due to the providing of the decoration blank comprised of a plurality of individual parts, a still greater diversity of design- and use-possibilities is given for the functional openings or for the decorative element.

In the manufacturing of the composite, in which the decoration blank and the application material layer are adhered with each other, in a further example of the method it is provided that between the decoration blank and the application material layer, a permanent adhering region and a functional opening region, different therefrom, are identified. In the permanent adhering region, a lastingly strong and stable adhesive connection is produced between the decoration blank and the application material layer by the adhesive layer. In the functional opening region, after the through-cutting of the decoration blank the waste piece is removed. In order to facilitate or to support the removing of the waste piece from the processed composite, with the adhering of the decoration blank with the application material layer, more adhesive or a different adhesive is applied in the permanent adhesive region than in the functional opening region. Thus in order to expose the functional opening, the waste piece can be particularly easily removed from the application material layer. For example, the respective functional opening region (I.e., a region of the composite in which the functional opening is formed) is provided only with adhesive points or adhesive islands or adhesive concentrations that are spaced from one another. In other words, the adhesive layer can be formed by the adhesive points that are spaced from one another. In addition, it is conceivable that in the functional opening region a two-sided adhesive coating (that is, on the adhesive side of the decoration blank and on the adhesive side of the application material layer) is omitted. Alternatively or additionally the decoration blank and/or the application material layer are coated with a less-adhering adhesive in the functional opening region. The permanent adhesive region can furthermore be generated by the lamination adhesive (in particular through the application material layer) flowing between the application material layer and the decoration blank during the laminating-on of the completed decoration blank. There the laminating adhesive connects with the adhesive via which the two layers are connected with each other or fixed against each other.

It is furthermore conceivable that a pre-adhesive is first applied between the decoration blank and the application material layer, which pre-adhesive is configured less strongly adhering in comparison with the final adhesive. For example, the decoration blank and the application material layer can initially be fixed against each other by the first component of a two-component adhesive. In this way the waste piece can be particularly easily removed, in particular together with a portion of the first adhesive component adhering to the waste piece. Here a corresponding tempering of the waste piece to be removed and/or of the adhesive component portion adhering thereto can facilitate the easy removal. For the final adhering a further adhesive or a second component of the two-component adhesive is brought between the decoration blank and the application material layer, for example, by the second adhesive component or the further adhesive penetrating it from the lamination side of the application material layer. Such a process is described further below in connection with the filler material. In addition it can be provided that further adhesive or the second adhesive component flows-in into one or more functional openings. Accordingly the second adhesive component or the further adhesive can be the filler material or a component of the filler material.

The decorative element obtains its mechanical properties, for example, a certain bendability, a certain tensile strength, a certain elasticity, a certain resistance against impression, etc. by it being formed from the decoration blank and the application material layer finally adhered therewith. Optionally the mechanical properties of the decorative element can be achieved by an appropriate selection and/or by an appropriate use of the filler material. In other words, the mechanical properties that the decorative element possesses are at least codetermined by the application material layer and/or by the filler material.

Alternatively or additionally the waste piece can be particularly easily or more easily removed by it (with or without the portion of the adhesive adhering thereto) being removed before a final solidifying of the adhesive, that is, for example, before the adhesive is completely cured.

In addition, the adhesive side of the decoration blank can be coated with a polymer before the applying of the adhesive onto the decoration blank or before a bringing-into-connection with the adhesive applied onto the application material layer. This brings the advantage that, for example, a fiber tear in the functional opening during the removing of the waste piece is inhibited and at least reduced. Furthermore, due to the polymer coating an interference-free filling of the functional opening with the filler material is supported so that in the finished decorative element an unobstructed light emission is provided.

At least for a first cutting region along the functional opening contour, in a further example of the method a cutting depth is prescribed such that the cutting element in the cutting region cuts at most so deep into the composite that specifically the decoration blank is completely cut-through, but the adhesive layer is not completely cut-through, that is, at most is cut into. In particular, along the entire functional opening contour only the decoration blank is cut-through by the cutting element or by the laser beam, but a further layer of the composite is not completely cut-through. In this case the waste piece then only includes the decoration material portion, so that with removal/pulling off of the waste piece from the composite only decoration material is removed and the adhesive layer as well as the application material layer remain. Alternatively thereto it is conceivable that the adhesive layer has been configured such that in the region of the functional opening it is removed from the composite together with the decoration material portion of the waste piece. Furthermore in this case it can be (but need not be) provided in this case—when only the decoration blank is to be cut-through along the entire functional opening contour—that a further cutting of further layers of the composite is omitted. A particularly stable decorative element and a particularly stable functional opening, in particular light opening, result. Because adjacent to the functional- or light- or sound-opening the rest of the decoration blank is supported or held by the application material layer. The through-lighting of the light opening is then affected by the light-transparent application material layer and—if adhesive of the adhesive layer is left behind on the application material layer—through the adhesive layer. Because in general with the method it is provided in particular that the adhesive used, which forms the adhesive layer, is permeable for visible light at least in the cured state, that is, translucent, or transparent, in particular transparent with image fidelity.

Alternatively or additionally, in a further development of the method a further or second cutting region can be provided along the functional opening contour, for which further or second cutting region a second cutting depth is prescribed such that during the through-cutting of the decoration blank the cutting element cuts-through the adhesive layer in the second cutting region in the same cutting operation and cuts into the application material layer. In other words, a material thickness of the application material layer can be partially cut-through. In particular, using the cutting element or using the laser beam the decoration blank can be cut-through along the entire functional opening contour, and the application material layer can be cut into. Despite this cutting-into of the application material layer, the decorative element is particularly stable, in particular when the correspondingly cut functional opening is filled in with the filler material. Then the cut-into application material layer is further stabilized by the filler material. Starting from the visible side of the decoration blank, by cutting further than precisely up to the adhesive side of the decoration blank a reliable cutting-through of the decoration blank is provided, even when the decoration blank has a material thickness subject to tolerances. Furthermore, the waste piece can be particularly efficiently removed or pulled away, without possibly present material bridges in the decoration material between the waste piece and the rest of the decoration blank having to be torn off in an undesired manner or accidentally torn off, which would lead to a ragged edge of the functional opening.

Alternatively or in addition to the first cutting region and/or to the second cutting region, in a further development of the method a third cutting region can be prescribed along the functional opening contour, along which the functional opening is formed by the cutting/laser cutting, for which third cutting region a third cutting depth is prescribed such that during the cutting-through of the decoration blank, in the same cutting operation the cutting element completely cuts through the adhesive layer and the application material layer. Thus during the cutting in the third cutting region the composite is completely penetrated by the cutting element, that is, for example, by the laser beam. The third cutting region can extend along the entire functional opening contour. When this is the case, the functional opening is fillable with the filler material in a particularly easy manner, since after the removing of the waste piece—which is comprised of the decoration material portion, the adhesive portion, and the application material portion—an initially material-free region of the functional opening is easily accessible both from the visible side of the decoration blank and from the lamination side of the application layer.

With reference to the last three examples presented, it is also to be understood that for the cutting of the respective functional opening, during which the cutting element is guided one or more times by the cutting machine along the functional opening contour and the composite is thereby cut into or cut-through, the cutting depth with which the cutting element penetrates into the composite can, but need not, vary during the cutting of the functional opening. Thus it is also conceivable that the entire functional opening contour is traversed by the cutting element with the first cutting depth, or with the second cutting depth, or with the third cutting depth. In addition, during the cutting of the functional opening, the cutting element can start along the functional opening contour with a first of the three cutting depths, and in the further course of the cutting change once or multiple times into another of the two other cutting depths, as well as change between the two other cutting depths.

In the method it can furthermore be provided that the cutting, in particular laser cutting, is composed of a plurality of cutting operations that are carried out successively or at least partially temporally overlapping one another. It is conceivable, for example, that the cutting machine includes more than one cutting element that are used simultaneously or successively along the functional opening contour. In the case of the laser cutting machine, it can be provided that it simultaneously emits two, three, or more laser beams that successively or at least in part simultaneously process or cut the composite. For example, for this purpose each of the cutting elements or each of the laser beams is associated with one of the cutting operations.

In other words: for the cutting-through of the decoration blank a multi-step cutting process, in particular laser-cutting process, can be used. Using the laser-cutting machine, a region to be cut can be—in particular without removing the composite from the processing region between partial processes of the cutting, or repositioning it in the processing region—traversed multiple times or successively using identical or different settings of the laser-cutting machine. Thus the individual cutting operations and/or the individual cutting regions can be traversed using common, overlapping, and/or different trajectories or by trajectory repetitions. Here the same or different settings can be used, such as laser power, laser focus, feed speed, laser pulse size, laser cutter operating mode (sustained laser, intermittent laser, trepanning, percussion, etc.) and/or further laser setting parameters influencing the cutting.

A further development of the method thus provides, for example, that the cutting-through of the decoration blank and the cutting-in into the application material layer are affected in a first cutting operation, and—in the same clamping in which the composite is fixed in the cutting machine—in a second cutting operation the application material layer is completely cut-through. The first and the second cutting operation are affected in particular successively. Here after the first cutting operation and before the second cutting operation, at least the decoration material portion of the waste piece is removed, so that in the second cutting operation an unhindered cutting of the layers of the composite below the decoration blank is provided. Since the two cutting operations are affected in the same clamping, a particularly advantageous edge quality results of the functional opening because the composite is not moved between the cutting operations. It can be cut using the first cutting operation or using a first laser incision of the first cutting region with the first cutting depth, in order to then be cut using the second cutting operation of the same cutting region with a larger cutting depth, in particular with the second cutting depth because the first cutting region and the second cutting region or associated laser trajectories can be congruent.

If at least two functional openings are generated by the two cutting operations, in a further example of the method it is provided that in the first cutting operation a bridge made of a material of the decoration blank is formed that connects two decoration material parts with each other of the waste piece, which decoration material parts correspond to the functional openings.

In other words, a cutting of the functional opening contour is omitted in the regions in which the waste pieces or their decoration material portions are to be connected with each other. Because the pulling out or removing of the waste piece is thus facilitated in particular when it is particularly small and consequently can only be handled with difficulty individually. A risk that these particularly small waste pieces individually disrupt the manufacturing of the decorative element, for example, when they fall into a machine involved in the production of the decorative element and/or fall in an undesired manner between the cutting element and the still-to-be-cut composite, is thus particularly low.

When in the first cutting operation the bridge is formed from the decoration material, at the openings at which the respective bridge opens into the waste piece connected by it, the application material layer has not been cut into or not been cut into to the same degree along the functional opening contour by the cutting element. At the openings the application material layer is therefore to be cut further in order to remove the application material portion of the waste piece. Therefore a tear region is defined or prescribed by the respective openings, at which the respective application material portion of the waste piece is torn from the rest of the application material layer. It is provided here in particular that the waste piece is removed only after the second cutting operation, in which the waste piece includes the decoration material portion and the application material portion adhered thereto. Upon the removal of the waste piece, in the respective tear region the application material portion is torn off as intended from the rest of the application material layer. Consequently it is avoided that during the removal from the composite, the waste piece separates in an undesired manner into its decoration material portion and application material portion, so that in an advantageous manner only one waste piece need be handled.

In order to particularly efficiently result in the tearing off of the application material portion of the waste piece from the rest of the application material layer, in particular such that damage to the rest of the application material layer is inhibited, a further example of the method provides to form the tear region before the tearing off as a predetermined tearing point, for example, by a cutting-in or perforating, for example, using the cutting machine, in particular laser-cutting machine. Here the application material layer is only perforated, pierced, or weakened in another way at the openings or at the designated tear regions through the decoration blank such that for the tearing off of the application material portion of the waste piece from the rest of the application material layer a particularly low force is needed. Furthermore, due to the perforating/weakening a particularly clean tear formation results in a desired manner at the functional opening contour.

In order to achieve, despite the tearing off of the application material portion of the waste piece from the rest of the application material layer, a particularly accurately shaped edge along the functional opening contour, in a further example it can be provided to cut off possible residues of the tear region that protrude into the functional opening. For this purpose a further cutting operation of the cutting machine can be used.

For the filling of the cut functional opening with the filler material, in a further development of the method it is provided to provide the filler material for the filling of the light opening in an at least pasty, in particular liquid state, so that during the filling or upon the filling of the light opening a material-bonded connection is produced between the decoration blank and the filler material. Because generally it can be provided with the method or with the decorative element that the filler material has at least adhesive properties of an adhesive. Accordingly, for example, an adhesive can be used as the filler material. Due to the adhesive-type, that is, material-bonded, connection between the filler material and the decoration blank—and in particular between the filler material and the adhesive layer and/or the application material layer—a particularly stable structure of the decorative element results.

In the case that starting from the visible side of the decoration blank only the decoration blank has been completely cut-through, according to a further example it applies that the application material layer and the adhesive layer are provided fluid-permeable, and the filler material is introduced from the lamination side of the application material layer into the corresponding functional openings by the application material layer and the adhesive layer being supersaturated with the filler material, so that first the application material layer and then the adhesive layer are flowed-through by the filler material toward the visible side of the decoration blank, whereby the filler material flows into the functional opening upon an exiting out of the adhesive layer. In contrast, if during the cutting both the decoration blank and the adhesive layer have been completely cut-through, or if the adhesive layer has also been removed in the region of the functional opening during the removing of the waste piece, it is conceivable to configure or provide only the application material layer as fluid-permeable. It then applies in this case that the application material layer is provided fluid-permeable, and the filler material is introduced from the lamination side of the application material layer into the corresponding functional opening by the application material layer being supersaturated with the filler material, so that the application material layer is flowed-through by the filler material toward the visible side of the decoration blank, whereby the filler material flows-in into the functional opening upon an exiting out of the application material layer.

In any case enough fluid/pasty filler material is brought into direct contact with the lamination side of the application material layer that the application material layer and possibly the adhesive layer is or are saturated with the filler material, and subsequently at least in the region of the functional opening is or are completely soaked or saturated, which causes that the filler material flows in through the application material layer and possibly through the adhesive layer into the functional opening. At the latest after the flowing-in into the functional opening, the filler material cures, for example, passively or with by addition of an activator or curing agent, of heat or other radiation, for example, ultraviolet light, etc. In the cured state the filler material is, for example, hardened and in any case translucent. In this case “hardened” does not necessarily mean that the filler material is rigid or brittle in the cured state, rather “hardened” is to be understood herein to mean that under normal conditions no further relevant solidity increase is to be expected. Accordingly the filler material can be flexible in this completely hardened state. In particular, the filler material is selected such that in the cured state with respect to bendability, stability, etc. it corresponds to a bendability or stability of the decoration material with corresponding properties.

On the one hand a particularly stable decorative element thereby results, and on the other hand with the method it is associated with particularly little effort to fill in the functional opening with the filler material. Because a cutting of the application material layer can be omitted, whereby an entire cutting process for the forming of the functional opening is shown to be particularly short. Particularly short dwell times can be maintained with the use of the cutting machine, which is particularly favorable.

Such a process in which a fluid, in the present case the liquid/pasty filler material, which completely penetrates the lamination side of the application material layer and consequently the application material layer, is usable in an analogous manner on the two adhesive components or the further adhesive.

If during the cutting of the composite, that is, during the forming of the corresponding functional opening, the application material layer is cut-through, an alternative approach for the filling of the functional opening with the filler material is considered: the filler material in this case is introduced through openings in the adhesive layer and in the application material layer into the functional opening or light opening. In this way a particularly efficient filling of the functional opening is provided.

According to a further possible example of the method, for the filling of the light opening with the filler material, the visible side of the decoration blank including the light opening and a seal element can be fixed against each other such that the light opening is fluid-sealed by the seal element on the visible side against an exiting of filler material onto the visible side. It is thus provided that no filler material reaches the visible side of the decoration blank, which would have to be removed again after the filling. Accordingly the method delivers a particularly clean decorative element that can be laminated onto the carrier structure as intended without a cleaning step beforehand. This again contributes to a particularly efficient manufacturing method. Optionally at least the region of the composite or of the decorative element can be subsequently pressed or subsequently sintered in order to achieve a particularly good homogenization of the filler material filled in the functional opening—for example, for a particularly homogenous light distribution.

The decorative element is provided for a motor vehicle, in particular its interior. The decorative element is/will be manufactured using a method formed according to the preceding description, and includes at least one functional opening. In the intended installation position, that is, when the decorative element has been inserted as intended in the interior of the motor vehicle, the visible side of the decoration blank faces into the interior of the motor vehicle so that an occupant of the motor vehicle sees the visible side upon observing the decoration blank. Here the adhesive side of the application material layer faces toward the interior of the motor vehicle, while the adhesive side of the decoration blank faces away from the interior. The adhesive side of the decoration blank and the adhesive side of the application material layer are facing each other and adhered with each other.

In particular, the decorative element is part of an interior illumination system. For this purpose the decorative element then includes at least one functional opening that is configured as light opening. In this case the motor vehicle includes a light source from which in an activated state visible light is decoupled. Here the light source and the decorative element are oriented with respect to each other, or directly or indirectly (for example, using a light conducting device) connected to each other in a light conducting manner such that light decoupled from the light source filters-through through the light opening(s), in particular through the respective filler material, and in this way radiates into the interior of the motor vehicle. Due to the (in particular milky) translucence of the decorative element, at least in the region of the light opening, a diffuse illumination pattern advantageously results, which, for example, can be efficiently used for ambient lighting purposes.

The light source includes one illuminant or more illuminants and is in particular configured to radiate a so-called RGB illumination. Accordingly the light source is in particular an RGB light source. Examples for the respective illuminants, that can form the light source individually or at least groupwise, are: An incandescent lamp; a light-emitting diode (LED), in particular an organic LED (OLED); an LED chain or an LED band; and an (in particular light-conducting) textile structure, in which one or more illuminants is/are incorporated. In particular this textile structure can be the application material layer that includes the illuminant or the illuminants in the functional opening region.

The light-conducting device includes one light-conducting element or more light-conducting elements, for example, an LED band or an LED chain. Examples for the respective light-conducting element that can at least partially form the light-conducing device individually or at least groupwise with each other, are: A flat light conductor, for example, made of polycarbonate, made of poly(methyl methacrylate) or from another plastic suitable for conducting light; a plurality of illuminants of the light source (in this case preferably a plurality of LEDs) are arranged laterally on narrow sides of the flat light conductor. The light is, for example, introduced in a lateral plate or in a dimensionally stable injection-molded lamination carrier. A light-conducting cord, in which the generated light is introduced via a coupled illuminant (in this case preferably an LED). A flat textile, in which light-conducing threads are introduced. This lies between the carrier structure and the decorative element laminated onto it. A textile structure in which one light-conducting element or more light conducting elements is/are incorporated. In particular this textile structure can be the application material layer that includes the illuminant or illuminants and/or one or more of the light-conducting elements at least in the functional opening region.

Alternatively or additionally the decorative element can be part of a loudspeaker system in the interior of the motor vehicle, for example, be disposed as cover over a loudspeaker. For this purpose the decorative element then includes at least one sound opening.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a decoration blank, of an adhesive layer and of an application material layer, which are provided in a method for the manufacturing of a decorative element according to the present disclosure;

FIG. 2 is a schematic view of a cutting machine in which a sectional view of a composite made of the decoration blank, the adhesive layer, and the application material layer is clamped according to the present disclosure;

FIG. 3 is a schematic view of a part of the composite, which is processed by the laser-cutting machine, in which a laser beam of the laser-cutting machine penetrates into the composite a) with a first cutting depth, b) with a second cutting depth, and c) with a third cutting depth according to the present disclosure;

FIG. 4 is a schematic view of the composite, which is processed by two cutting operations using the laser-cutting machine according to the present disclosure;

FIG. 5 is a schematic view of the composite in which during the processing using the laser-cutting machine a bridge is formed between decoration material parts of a waste piece according to the present disclosure;

FIG. 6 is a schematic view of the composite that has been processed using the laser cutting machine, in which a functional opening is filled in with a filler material that flows through the application material layer according to the present disclosure;

FIG. 7 is a schematic view of the composite that has been processed using the laser-cutting machine, wherein a functional opening is filled with a filler material that flows-in into the functional opening through an opening cut into the application material layer by the laser-cutting machine according to the present disclosure;

FIG. 8 is a schematic sectional view of the decorative element that has been produced using the method and includes functional openings according to the present disclosure; and

FIG. 9 is a schematic view of the decorative element, in which the decoration blank is composed of two decoration blank parts according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

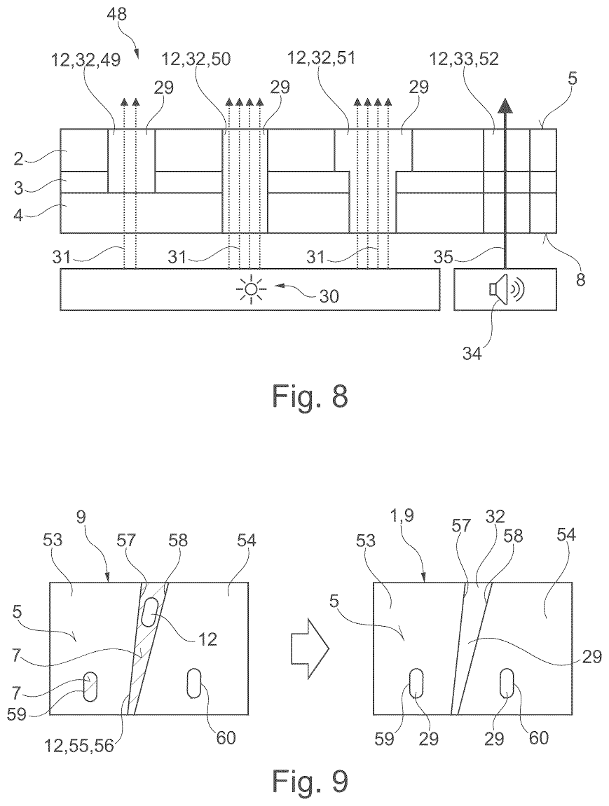

Identical and functionally identical elements are provided in the Figures with identical reference numbers. In the following a method for the manufacturing of a decorative element 1 (see FIG. 8) and the decorative element 1 itself shall be presented in a common description. It generally applies that when one feature or more features of a functional opening 12, 49, 50, 51, 52, 59, 60 introduced further below are described herein, the corresponding feature or the corresponding features can correspondingly be applied to the other of the functional openings 12, 49, 50, 51, 52, 59, 60.

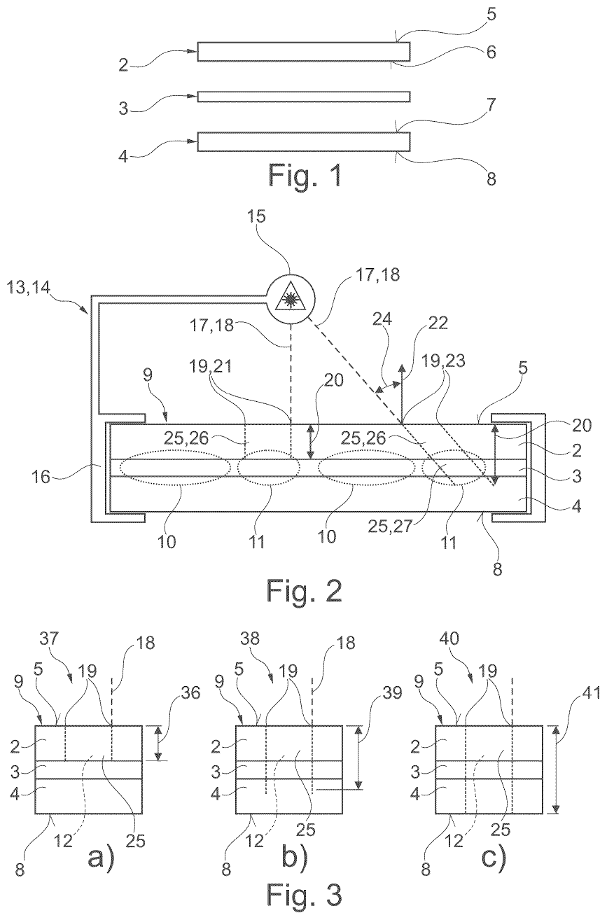

For this purpose FIG. 1 shows in schematic view a decoration blank 2, an adhesive layer 3, and an application material layer 4 that are provided in a first step of the method for the manufacturing of a decorative element 1. Merely by way of example the decoration blank 2 is formed from a leather or leather-like material and thus flexible or pliable. The decoration blank 2 includes a visible side 5 and an adhesive side 6 that are opposite each other and spaced by a material thickness of the decoration blank 2. The adhesive side 6 of the decoration blank 2 can in the present case—since it is formed from leather or a leather-type material—be referred to as finishing side. In the present example, the application material layer 4 is formed from a textile and flexible or pliable, in particular to a similar or the same degree as the decoration blank 2. Furthermore, the application material layer 4 is permeable for light that is visible by a person with physiological eyes without further aid. This means that the application material layer 4 is permeable for light that has a wavelength of approximately 380 nm (nanometers) to approximately 780 nm. the application material layer 4 includes an adhesive side 7 and a lamination side 8 that are opposite each other and spaced from each other by a material thickness of the application material layer 4.

In a further step of the method, the decoration blank 2 and the application material layer 4 are adhered by the adhesive layer 3 into a composite 9 (see FIG. 2). For this purpose the adhesive layer 3 or an adhesive forming the adhesive layer 3 is brought between the decoration blank 2 and the application material layer 4, in which the adhesive sides 6, 7 respectively of the adhesive layer 3 or the adhesive are facing each other. It can be provided that the adhesive is applied onto the adhesive side 6 and/or onto the adhesive side 7, and then the adhesive sides 6, 7 are moved toward each other until the adhesive applications together form the adhesive layer 3 between the decoration blank 2 and the application material layer 4. Consequently the decoration blank 2 and the application material layer 4 are connected with each other in a material-bonded manner.

In the present case it is provided that between the decoration blank 2 and the application material layer 4 at least one permanent adhesion region 10 and at least one functional opening region 11 different therefrom are identified. In the permanent adhesion region 10 a lastingly strong and stable adhesive connection is produced between the decoration blank 2 and the application material layer 4. In the functional opening region 11, in further steps of the method a functional opening 12 (first shown in FIG. 8) is formed so that at this location a particularly solid and lastingly strong adhesive connection may be omitted. Therefore in the present example less adhesive or a different adhesive is used in the functional opening region 11 in the present example than in the permanent adhesion region 10. For example, the respective functional opening region 11 is simply provided with adhesive points spaced from one another, so a two sided adhesive coating is omitted. Alternatively or additionally, the deco-ration blank 2 and/or the application material layer 4 are/is coated with a less-adhering adhesive in the functional opening region 11.

In a further method step the composite 9 is clamped in a cutting machine 13, which in the present example is configured as a laser-cutting machine 14. Here the composite 9 is clamped in the laser-cutting machine 14 such that the visible side 5 of the decoration blank 2 and a laser emitter unit 15 of the laser-cutting machine 14 are facing each other, while the lamination side 8 faces away from the laser emitter unit 15. FIG. 2 accordingly shows a schematic view of the laser-cutting machine 14 that includes a clamping device 16 in which the composite 9 (shown in cut view) is clamped. The clamping device 16 and the laser emitter unit 15 can be movable relative to each other so that in a cutting operation of the laser-cutting machine 14 the laser emitter unit can be moved with respect to the composite 9. The laser-cutting machine 14 includes—also like every other cutting machine 13—a cutting element 17 that includes a laser beam 18 or a plurality of laser beams 18 that in the cutting operation of the laser-cutting machine 14 are sent from the laser emitter unit 15 toward the clamped composite 9, and in particular into the clamped composite 9. Here the laser-cutting machine 14, which in the present case is a computer-controllable laser-cutting machine, i.e., for example, a CNC laser-cutting machine, is configured to cut-in the functional opening 12 or more functional openings 12 into the composite 9.

In a further step of the method, a processing is then affected of the composite 9 using the laser-cutting machine 14 in order to form the respective functional opening 12. Here at least the decoration blank 2 is cut-through along a prescribed or prescribable functional opening contour 19 using the laser-cutting machine 14. The cutting-through of at least the decoration blank 2 is thus affected by laser cutting. As can further be seen from FIG. 2, the cutting element 17 of the cutting machine 13, i.e., here the laser beam 18 of the laser-cutting machine 14, impinges for through-cutting of the decoration blank 2 onto its visible side 5 and cuts-in or cuts-through the composite 9 toward the lamination side 8 of the application material layer 4 down to a prescribed or prescribable cutting depth 20. Here the laser beam 18 impinges or at least a plurality of the laser beams 18 impinge—for example in a first functional opening con-tour section 21—perpendicularly onto the visible side 5, i.e., parallel to a surface normal 22 of the visible side 5. Additionally or alternatively, the laser beam 18 impinges, or at least a plurality of the laser beams impinge—for example, in a second functional opening contour section 23—obliquely onto the visible side 5. In this case the corresponding laser beam 18 and the surface normal 22 enclose an angle 24 with each other that is larger than 0° and smaller than 90°. It can be provided here that one and the same functional opening 12 includes both at least one first functional opening contour section 21 and at least one second functional opening contour section 23.

By the cutting of the decoration blank 2 a one- or multi-part waste piece 25 arises that is removed from the composite 9, for example by the waste piece 25 being pulled off of the composite. By the removing of the correspondingly associated waste piece 25, the functional opening 12 is formed. The functional opening can thus, for example, be formed by the decoration blank 2 being cut-through by the laser-cutting machine 14 along the corresponding functional opening contour 19 and then the waste piece 25 that includes at least one decoration material portion 26 being removed from the composite 9. When cutting—as shall be explained in more detail below—the functional opening 12 or its functional opening contour 19 the adhesive layer is also cut through, the waste piece 25 includes the decoration material portion 26 and an adhesive portion 27. If during cutting of the functional opening 12 or its functional opening contour 19 the application material layer 4 is also cut through, the waste piece 25 further includes an application material portion 28.

It is to be understood that the decorative element 1 can include more than one functional opening 12. In other words, it can be provided that during manufacturing of the decorative element 1, more than one functional opening 12 is cut into the composite 9. Here the functional openings 12 can be configured identically or different from one another.

In a further step of the method at least one of the functional openings 12 is completely or partially filled or filled in with a filler material 29 (see FIG. 6 and FIG. 7). In its cured state the filler material 29 is translucent, that is, permeable for visible light. If the completed decorative element 1 is illuminated with visible light 31 by an illuminant 30 (see FIG. 8) on the side of the lamination side 8, the light 31 then enters into the filler material 29 and exits from the decorative element 1 on the side of the visible side 5. In addition, during the filling of the functional opening 12 with the filler material, the adhesive- or finishing-side is at least partially coated, wetted, and/or soaked. This favors a light entry into the corresponding functional opening 12. In order to achieve a diffuse light distribution or light appearance at the visible side 5, in the present example it is provided that the filler material 29 is milky in the cured state. By the corresponding functional openings 12 being filled with the filler material 29, a light opening 32 (see FIG. 8) is at least partially formed from the functional opening 12.

The functional opening 12 or another of the functional openings 12 can furthermore at least partially be a sound opening 33 (see FIG. 8). In this case, the decorative element 1 can function as a decorative part of a cover element for a loudspeaker 34, in which sound waves 35 generated by the loudspeaker 34 then move through the sound opening 33. Because the sound opening 33 or a sound opening region of the corresponding functional opening 12 is not filled with the filler material 29 or kept free of the filler material 29 during filling of the light opening 32 or of a light-opening region of the corresponding functional opening 12. Alternatively the sound opening 33 or the sound-opening region can be produced by the filler material 29 being removed again from the corresponding functional opening 12 after the filling. Furthermore, the respective sound opening 33 may only be formed after the filling with the filler material. The cover element is spanned over a dimensionally stable injection-molded carrier that includes through-openings that correspond with the functional openings 12 in terms of positional location and geometry in order to make possible a particularly efficient sound-wave pass-through. The loudspeaker 34 is disposed spaced behind the injection-molded carrier.

FIG. 3 shows a schematic view of a part of the composite 9 that is processed by the laser-cutting machine 14, wherein the laser beam 18 of the laser-cutting machine 14 (case a)) penetrates into the composite 9 with a first cutting depth 36. Here the first cutting depth 36 is prescribed for a first prescribed or prescribable cutting region 37 along the functional opening contour 19 such that the cutting element 17 or the laser beam 18 in the cutting region 37 cuts-in at most deep enough into the composite 9 that specifically the decoration blank 2 is completely cut-through, but the adhesive layer 3 is not completely cut-through. In this case the functional opening 12 is formed or exposed by the waste piece 25 being removed from/out of the composite 9 after the cutting of the composite 9. Here the waste piece can be comprised only of the decoration material portion 26 or also include the adhesive portion. In any case, the functional opening 12 can be formed, wherein the application material layer 4 remains undamaged at least in regions in which the laser beam does not completely cut-through the adhesive layer 3, that is, at most incises. In regions in which between the application material layer 4 and the decoration blank 2—for example, since only adhesive points are provided in this region—during the cutting of the functional opening 12 it can happen that the application material layer 4 is incised, but is not completely cut-through.

In the case indicated in FIG. 3 as case b), the laser beam 18 penetrates into a second prescribed or prescribable cutting region 38 with a second cutting depth 39 in the composite 9, which cutting depth 39 is prescribed such that the cutting element 17 or the laser beam 18 cuts-through the adhesive layer 3 in the second cutting region 38 and cuts-in into the application material layer 4. This is affected, for example, by a single cutting process, i.e., in one and the same cutting operation. The functional opening 12 in this case is formed or exposed by the waste piece 25, which is comprised of the decoration material portion 26 and at least a part of the adhesive portion 27, being removed from/out of the composite 9 after the cutting of the composite 9. The application material layer 4 thereby remains perfusable by fluid, and no light influencing elements, such as leather fibers, etc. remain in the functional opening 12 or light opening 32. Provided the adhesive portion 27 has not been completely removed from the composite by the removal of the waste piece 25, a residue thereof can remain in the functional opening 12 or light opening 32 when the adhesive layer is translucent or transparent, in particular transparent with image fidelity, and the flow-through behavior during the filling of the functional opening 12 with the filler material 29 is not significantly influenced.

In FIG. 3 a third cutting region 40 (case c)) is furthermore shown, which is assigned a third cutting depth 41. Here the cutting element 17 or the laser beam 18 completely cuts-through—for example, using a single cutting process or in one and the same cutting operation—the decoration blank 2, the adhesive layer 3, and the application material layer 4, i.e., the entire composite 9. To form or expose the functional opening 12, the waste piece 25 is then removed, which in this case comprises the decoration material portion 26, the adhesive portion 27, and the application material portion 28.

Along a single, common functional opening contour 19, the cutting regions 37, 38, 40 can be provided individually, groupwise, or collectively. This means that for forming the respective functional opening 12, the cutting element 17 or the laser beam 18 penetrates into the composite with the first cutting depth 36, and/or with the second cutting depth 39, and/or with the third cutting depth 41.

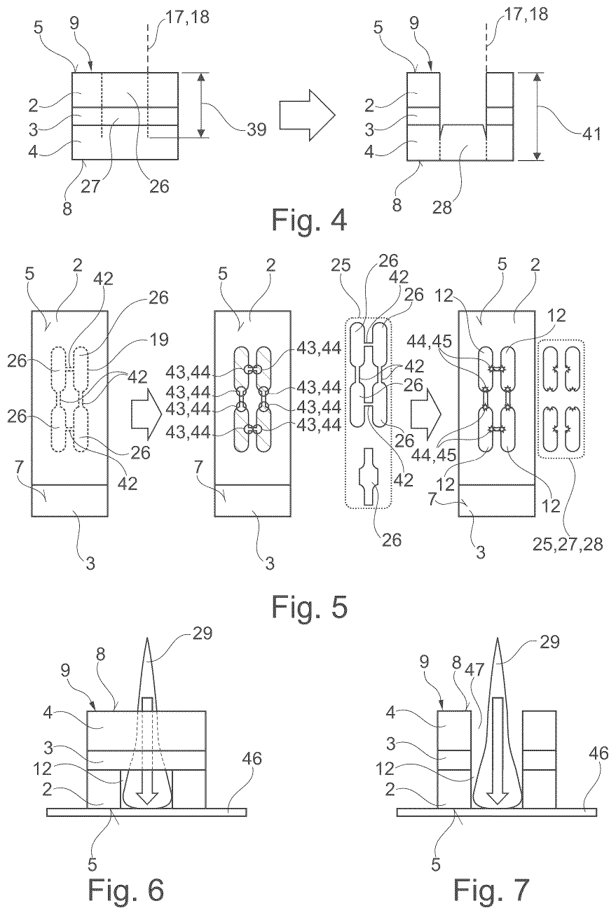

The cutting-through of the decoration blank 2 and the cutting-in into the application material layer 4 (case b)) can be affected in a first cutting operation, while in a second cutting operation the application material layer 4 is completely cut-through. For this purpose FIG. 4 shows a schematic view of the composite 9, which is processed by the laser-cutting machine 14 using the two cutting operations. In the first cutting operation (shown on the left in FIG. 4), the composite 9 is cut-into with the second cutting depth 39, and in the second cutting operation (shown on the right in FIG. 4) the composite 9 is cut-into with the third cutting depth 41. Here using the clamping device 16, the composite 9 remains in the laser-cutting machine 14 for both cutting operations and is clamped between the cutting operations, so that the composite 9 is not moved between the cutting operations. In the present case the two cutting operations are therefore successive. It can be provided that—as shown in FIG. 4—between the cutting operations the waste piece 25 accrued is at least partially removed. In FIG. 4 it is shown that the decoration material portion 26 and the adhesive portion 27 are removed from the composite 9 after the first cutting operation. The two cutting operations can alternatively at least partially overlap each other temporally or be performed completely simultaneously, for example, when a first laser beam 18 is generated or emitted for the first cutting operation, and simultaneously a second laser beam 18 is generated or emitted for the second cutting operation. Then when both cutting operations are concluded, the waste piece is removed that comprises the decoration material portion 26, the adhesive portion 27, and the application material portion 28.

In FIG. 5 a schematic view of the composite 9 is shown in plan view, in which during the processing by the laser-cutting machine 14 a bridge 42 is formed between decoration material portions 26 of the waste piece 25. It is to be noted that more than only one functional opening can be formed jointly—in the present case, and merely by way of example, four functional openings 12. Here the respective bridge 42 is formed between at least two of the functional openings 12, so that the corresponding decoration material portions 26 that emerge or are accrued during the cutting of the composite 9, are connected to each other by the bridges 42 or remain due to the bridges 42. Since during the forming of the bridges 42 between the decoration material portions 26 at openings 43 at which the bridges 42 open into the corresponding decoration material portions, during the cutting by the laser-cutting machine 14 the application material layer 4 remains left out or is not completely cut-through, during the removing of the corresponding application material portions 28 a tearing-off results of the application material portions 28 from the rest of the application material layer 4. At the respective opening 43 a respective tear region 44 of the application material layer 4 is formed at which the associated application material portion 28 is torn off during the removing of the waste piece 25 from the rest of the application material layer 4.

At the openings 43 or at/in the tear regions 44, the application material layer 4 can be incised, perforated, or weakened in another manner so that the respective tear region 44 is configured as predetermined tear point. During the removing of the waste piece 25, the tearing-off of the respective application material portion 28 from the rest of the application material layer 4 is thereby facilitated. In particular, the cutting machine 13, that is, the laser-cutting machine 14 is used for the producing of the predetermined tear points. If—as shown in FIG. 5—after the tearing-off of the respective application material portion 28 from the rest of the application material layer 4 a residue 45 remains of the corresponding tear region 44 remains that protrudes into the functional opening 12, the residue 45—for example, in a further cutting operation—can be cut off by the laser cutting machine 14.

FIG. 6 and FIG. 7 each show a schematic view of the composite 9, in which the functional opening 12 is filled with the filler material 29. For the filling of the functional opening 12 with the filler material 29, the filler material 29 is brought at least into a pasty, in the present case at least approximately liquid state, or is already provided in this state. This causes that during the filling of the functional opening 12 that is thereby at least partially formed as for light opening 32, a material-bonded connection is produced at least between the decoration blank 2 and the filler material 29. The composite 9 is thereby stabilized or strengthened by the filling with the filler material 29. For this purpose the filler material 29 has adhesive properties of an adhesive or is an adhesive.

In order to inhibit that the visible side 5 of the decoration blank 2 or of the decorative element 1 is soiled in an undesired manner by filler material escaping from the functional opening 12, in the present case the visible side 5 of the decoration blank 2 including the light opening 32 and a seal element are fixed against each other for the filling of the functional opening 12 or light opening 32, whereby the light opening 32, or the functional opening 12 which is formed for the light opening 32, is sealed against fluids on the visible side 5. It is thereby inhibited that filler material 29 escapes from the light opening 32 or functional opening 12 onto the visible side.

FIG. 6 shows a schematic view of the composite 9 that has been processed by the laser-cutting machine 14, in which the functional opening 12 is filled in with the filler material that flows through the application material layer 4. For this purpose—when during removing of the waste piece 25 in the region of the corresponding functional opening 12, the adhesive layer 3 is also removed—the application material layer 4 is provided fluid-permeable. The filler material is then contacted directly with the lamination side 8, so that the at least approximately liquid filler material 29 can penetrate into the application material layer 4. With a steady inflow of filler material 29 toward the lamination side 8, the application material layer 4 is saturated with filler material 29 until the application material layer 4 is supersaturated in the region of the functional opening 12 to be filled. Due to the supersaturation, the filler material 29 flows out onto the adhesive side 7 from the application material layer 4, and consequently into the functional opening 12. The filler material 29 is thus introduced from the lamination side 8 of the application material layer 4 into the corresponding functional opening 12, wherein the application material layer 4 is flowed-through by the filler material 29 toward the visible side 5 of the decoration blank 2, whereby the filler material 29 flows-in into the functional opening 12.

When during removing of the waste piece in the region of the corresponding functional opening 12 the adhesive layer 3 was not also removed, under the constant inflow onto the lamination side 8 the filler material 29 supersaturates and flows-through first the application material layer 4 and then the adhesive layer 3. Due to the supersaturation the filler material 29 flows out onto the adhesive side 7 out of the application material layer 4, and consequently into the adhesive layer 3. With a flowing-out from the adhesive layer 3, the filler material 29 then flows into the functional opening 12.

In any case the filler material is introduced from the lamination side 8 of the application material layer 4 into the corresponding functional opening 12, wherein the application material layer 4 is flowed-through by the filler material 29 toward the visible side 5 of the decoration blank 2, whereby the filler material flows-in into the functional opening 12. For this purpose the application material layer 4 and possibly the adhesive layer 3 are provided fluid-permeable—that is, at least permeable for the filler material 29 when it is in the liquid, approximately liquid, or pasty state. For the adhesive layer 3, this means that the adhesive layer 3 or the adhesive forming the adhesive layer 3 is permeable in the cured state for the filler material 29 in the liquid, approximately liquid, or pasty state.

In FIG. 7 an alternative is shown in order to guide the filler material 29 in to the functional opening 12. FIG. 7 shows a schematic view of the composite 9 that has been processed using the laser-cutting machine 14, in which the functional opening 12 is filled in with the filler material 29 that flows in through an opening 47, cut into the application material layer 4 by the laser-cutting machine 14, into the functional opening 12. Consequently in this case during the forming of the functional opening 12 using the laser-cutting machine 14, the application material layer 4 is cut-through so that the correspondingly arising waste piece 25 includes the application material portion 28.

FIG. 8 shows a schematic and cut view of the decorative element 1 that has been manufactured using the method and includes functional openings 12. The decorative element 1 is provided for an interior 48 of a motor vehicle (not shown). In the intended installation position of the decorative element 1 it forms a component of the motor vehicle. The decorative element 1 is in particular an interior element, i.e., for example, a cover element for the loudspeaker 34, a door panel, etc., or another cladding- and/or cover-element. Here the visible side 5 of the decorative element 1, that is, the visible side 5 of the decoration blank 2 faces into the interior 48, while the lamination side 8 of the decorative element 1, that is, the lamination side 8 of the application material layer 4, faces out of the interior 48.

In FIG. 8 it is also to be noted that the decorative element 1 includes more than one functional opening 12—in the present case four functional openings 12. Here a first functional opening 49, a second functional opening 50, and a third functional opening 51 are each configured as a light opening 32, wherein a fourth functional opening 52 is configured as a sound opening 33. On the example of the third functional opening 51, it is to be noted that the respective functional opening 12 can have different designs, diameters, etc. along the material thickness of the composite 9 or of the decorative element 1.

FIG. 9 shows a schematic view of the decorative element 1, in which during the manufacturing of the decorative element 1 the decoration blank 2 is composed of at least two decoration blank parts 53, 54. The decoration blank parts 53, 54 are initially provided separate from each other and then, with the forming of at least one edge opening 55 or edge gap between them, adhered with the application material layer 4. A further functional opening 56 is thus formed by the edge opening 55. It can be provided that the edge gap or the edge opening 55 is cut by at least one cut using the laser-cutting machine 14 (first cutting depth), for example, in order to respectively straighten the mutually opposing edges 57, 58. Furthermore, it can be provided that inside a material-free space, by which the mutually facing edges 57, 58 are spaced from each other, a (further) functional opening 12 is cut-in into the composite 9, in particular into the application material layer 4 (second cutting depth). In this case the waste piece 25 is free of material of the decoration blank 2 or of the decoration blank parts 53, 54. The edge opening 55 can be filled or filled in according to the above description with the filler material 29 when a light opening 32 is to be formed by the edge opening 55. The edges 57, 58 can extend parallel to each other or obliquely to each other. Furthermore, one or both of the edges 57, 58 can be configured uneven.

Since the decoration blank parts 53, 54—and possibly at least one further decoration blank part (not shown) —together form the decoration blank 2, it is clear that one or more of the decoration blank parts, for example, one or both of the decoration blank parts 53, 54, can include one of the functional openings 12. This is shown in FIG. 9 by the functional openings indicated with 59, 60. here the functional opening 59 is formed by the decoration material of the decoration blank part 53 having been completely cut-through, but the application material layer 7 having been at most incised, wherein the associated waste piece 25 in this case is free from material of the application material layer 7. In the present case the functional opening 7 was generated by both the material of the decoration blank part 54 and the application material layer 7 having been completely cut-through in the respective region, whereby the associated waste piece 25 then includes decoration material of the decoration blank part 54 and material of the application material layer 7.

In general, the design possibilities in the decorative element 1 or in the manufacturing of the decorative element 1 using the method described herein are unlimited—it is, for example, made possible, after the removing of the waste piece 25 that is comprised at least partially of the material of the decoration blank 2, to insert an insert piece (not shown) made of the decoration material or a different material, in particular a different decoration material, at the location of the waste piece 25, that is, in the opening that has been cut into the decoration blank 2. This means that an insert piece can be inserted in one or more of the functional openings 12, 49, 50, 51, 52, 59, 60. Furthermore, two or more insert pieces can be used and each inserted in one or more of the functional openings 12, 49, 50, 51, 52, 59, 60. Here the respective insert piece can be a different color, differently structured, or have different surface properties, and/or of a different design/geometry than the cut-out waste piece 25 or than the surrounding decoration material. For example, a circular-disk-shaped (or shaped according to any other geometrically closed curve) portion can be cut out from the decoration blank 2 and removed. The insert piece can also be shaped according to a geometrically closed curve, for example, formed oval, star-shaped, serrated, etc. In addition, the insert piece has different light-transmission properties than the cut-out waste piece 25 or the surrounding decoration material. It can be, for example, less or more transparent.

In order to provide a particularly precise in particular precisely repeatable positioning of the insert piece, it can also be provided that—explained on the basis of circular shapes merely by way of example—first two (in particular concentric) circles are cut-in into the decoration material so that a circular ring and an inner circle remain as waste piece 25. Then the inner circle is removed from the composite 9, wherein the circular ring initially remains on the composite 9. In the now free inner region of the circular ring, the insert piece is then appropriately inserted, wherein an outer contour of the insert piece and an inner contour of the circular ring correspond with each other. The circular ring cut free thus functions as positioning aide for the positionally precise inserting of the insert piece. In order to then fill the functional opening 12 with the filler material 29, the circular ring is removed from the composite.

Furthermore, the insert piece can include an electrical or electronic component, or be formed from the electric or electronic component. The electrical or electronic component is, for example, a sensor, a control, an illuminant, a light-guide element, etc. Such an electric or electronic com-ponent can alternatively or additionally—in particular prior to the filling of the functional opening 12—be inserted into the functional opening 12 so that the functional opening 12 serves as receptacle for the electric or electronic component. This sits particularly securely in the functional opening 12 by it being molded in the filler material 29.

The insert piece can furthermore be a grid- or frame-forming structure, for example, as ventilation grille.

By the method for the manufacturing of the decorative element 1 as well as by the decorative element 1 itself, possibilities are shown how the decorative element 1 is providable with at least one functional opening 12. Here the decorative element 1—despite the functional opening(s) 12—is laminatable particularly simply and efficiently with high lamination quality onto a carrier structure (not shown) and particularly stable and durable.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for manufacturing a decorative element, including a functional opening, for a motor vehicle, the method comprising:
providing a decoration blank that includes a visible side and an adhesive side, and an application material layer that includes an adhesive side and a lamination side;
producing a composite from the decoration blank and the application material layer by adhering the adhesive side of the decoration blank and the adhesive side of the application material layer with each other using an adhesive layer;
cutting through the decoration blank along a functional opening contour using a cutting element of a cutting machine to form a waste piece;
removing the waste piece to form the functional opening; and
filling the functional opening with a filler material that reacts into a cured state, in which the filler material is at least partially translucent, at least partially transparent, completely transparent, or light-impermeable.

2. The method according to claim 1,
wherein the cutting through of the decoration blank is by laser cutting.

3. The method according to claim 1,
wherein the cutting through of the decoration blank further comprises the cutting element impinging on the visible side of the decoration blank, and cutting through the composite toward the lamination side of the application material layer down to a predetermined cutting depth.

4. The method according to claim 3,
wherein in a first functional opening contour section the cutting element impinges onto the visible side of the decoration blank parallel to a surface normal of the visible side of the decoration blank.

5. The method according to claim 3,
further comprising providing a first cutting depth for a first cutting region along the functional opening contour such that the cutting element in the first cutting region cuts into the composite that the decoration blank is completely cut through without completely cutting through the adhesive layer of the decoration blank.

6. The method according to claim 5,
wherein for the filling of the functional opening with the filler material, the method further comprises fixing the visible side of the decoration blank including the functional opening against a seal element, the functional opening sealed against fluids by the seal element on the visible side and against an escape of filler material onto the visible side.

7. The method according to claim 5,
further comprising providing a second cutting depth for a second cutting region along the functional opening contour, and during the cutting through of the decoration blank in the second cutting region the cutting element cuts through the adhesive layer and cuts into the application material layer in the same cutting operation.

8. The method according to claim 7,
further comprising providing a third cutting depth for a third cutting region along the functional opening contour, and during the cutting through of the decoration blank in the third cutting region the cutting element completely cuts through the adhesive layer and the application material layer in the same cutting operation.

9. The method according to claim 8,
further comprising introducing the filler material into the functional opening through a plurality of openings cut into the adhesive layer and into the application material layer.

10. The method according to claim 7,
further comprising performing the cutting through of the decoration blank and cutting into the application material layer in a first cutting operation, and in clamping the composite to the cutting machine in a second cutting operation the application material layer is completely cut through.

11. The method according to claim 10,
further comprising forming at least two functional openings in the first cutting operation, and a bridge made of a material of the decoration blank is provided that connects with two decoration blank parts corresponding with the at least two functional openings.

12. The method according to claim 11,
wherein the waste piece includes an application material portion, and the waste piece is torn off in a tear region from the application material layer,
wherein prior to the tearing off of the waste piece of the application material layer, the method further comprises forming the tear region as a predetermined tear point.

13. The method according to claim 12,
wherein in a further cutting operation, the method further comprises cutting off residues of the tear region that protrude into the functional opening.

14. The method according to claim 4,
wherein in a second functional opening contour section the cutting element impinges onto the visible side of the decoration blank obliquely to a surface normal of the visible side of the decoration blank.

15. The method according to claim 14,
wherein the cutting through of the decoration blank by the cutting element along the second functional opening contour generates a further functional opening that forms a sound opening and a second waste piece that is removed, wherein during the filling of the functional opening with the filler material, the sound opening is at most partially filled with the filler material.

16. The method according to claim 1,
wherein the decoration blank is formed from two mutually separate decoration blank parts that are adhered together with the application material layer and with formation of an edge opening between the two mutually separate decoration blank parts, wherein a second functional opening is formed by the edge opening.

17. The method according to claim 1,
further comprising providing a permanent adhesion region and a functional opening region between the decoration blank and the application material layer, the permanent adhesion region is an adhesive connection between the decoration blank and the application material layer by the adhesive layer, after the cutting through of the decoration blank the waste piece is removed to form the functional opening region, and during the adhering of the decoration blank and the application material layer in the permanent adhesion region, more adhesive is applied than in the functional opening region.

18. The method according to claim 1,
wherein the filler material for the filling of the functional opening is provided in a liquid state and the method further comprises producing, during the filling of the functional opening, a material-bonded connection between the decoration blank and the filler material.

19. The method according to claim 18 and,
wherein the application material layer and the adhesive layer are fluid-permeable, the method further comprises introducing the filler material from the lamination side of the application material layer into the functional opening by the application material layer, the adhesive layer being supersaturated with the filler material, the application material layer and the adhesive layer are flowed through by the filler material toward the visible side of the decoration blank, and the filler material flows in into the functional opening.

20. A decorative element for a motor vehicle, wherein the decorative element is produced by a method that is formed according to claim 1, and includes the functional opening.
